(19) United States
(12) Patent Application Publication
(10) Pub. No.: US 2025/0188942 A1
(43) Pub. Date: Jun. 12, 2025

(54) METHOD FOR OPERATING A FLOW PRODUCING SYSTEM ALS WELL AS A FLOW PRODUCING SYSTEM

(71) Applicant: ebm-papst Mulfingen GmbH & Co. KG, Mulfingen (DE)

(72) Inventors: Martin Schmitt, Gruensfeld (DE); Alexander Hertrich, Doerzbach (DE)

(21) Appl. No.: 18/977,316

(22) Filed: Dec. 11, 2024

(30) Foreign Application Priority Data
Dec. 12, 2023 (DE) 10 2023 134 798.5

(51) Int. Cl. F04D 25/06

(52) U.S. Cl. CPC F04D 25/06

(57) ABSTRACT

The present disclosure refers to a method for operating a flow producing system as well as a flow producing system configured to carry out the method. The flow producing system has at least one flow producer group having multiple flow producing units respectively. The flow producing units can be fans, for example. The flow producing units of a common flow producer group are fluidically connected to a common flow space and are controlled by means of a control device to which a set point parameter is predefined for open-loop or closed-loop control purposes. At least one flow producing unit from the flow producer group is selected and an individual set point operating condition is determined respectively. The respectively determined set point operating condition is checked for allowability based on an individual operation limitation in each case. If necessary two or more set point operating conditions are modified until all of the set point operating conditions of the selected flow producing units are allowable.

### CROSS REFERENCE TO RELATED APPLICATIONS

This application claims priority under 35 U.S.C. § 119 to the following German Patent Application No. 10 2023 134 798.5, filed on Dec. 12, 2023, the entire contents of which are incorporated herein by reference thereto.

### TECHNICAL FIELD

The present disclosure refers to a method for operating a flow producing system as well as a flow producing system having a control device that is configured to carry out the method. The flow producing system has at least one flow producer group that can be controlled by means of the control device and that comprises multiple flow producing units. Each flow producing unit is configured to create an individual fluid flow. The fluid flow can be a gas flow or a liquid flow. Preferably, the flow producing unit is configured as fan or comprises a fan and is configured for producing an air flow.

### BACKGROUND

EP 3 749 864 A1 discloses a method for determination of operating conditions of a fan, an arrangement of multiple fans, fan groups or fan systems. Thereby, the individual fans of a fan arrangement can be operated in coordinated manner. A digital representation of the real fan is created by means of mathematical calculation models and known data, for example measurement data, that maps the operation of the real fan. A predictive maintenance having the object of a maximum possible lifetime shall be achieved. Critical system conditions, for example resonances or high temperatures shall be avoided.

In practice it is often difficult to predict changes occurring with increasing operation duration in a flow producing system.

### BRIEF SUMMARY

Therefore, it can be considered as object of the present disclosure to provide a method and a flow producing system that provides an optimized operation of a flow producer group having multiple flow producing units under consideration of occurring changes with increasing operation duration.

Disclosed is a method for operating a flow producing system comprising a control device and a flow producer group that can be controlled by means of the control device and that comprises multiple flow producing units, which are respectively configured to create an individual fluid flow, wherein the flow producing units are fluidically connected with a common flow space, wherein the method includes: setting at least one set point parameter that is to be controlled for atmosphere in the flow space, selecting at least one flow producing unit from the flow producer group and determining an individual set point operating condition for each selected flow producing unit under consideration of repeatedly determined individual operation limitations in order to control the at least one set point parameter.

Also disclosed is a flow producing system including a control device and a flow producer group that can be controlled by means of the control device and that comprises multiple flow producing units that are respectively configured to create an individual fluid flow, whereby the flow producing units are fluidically connected to a common flow space, wherein the control device is configured to carry out the following method: setting at least one set point parameter to be controlled for the flow space, selecting at least one flow producing unit from the flow producer group and determining an individual set point operating condition for each selected flow producing unit under consideration of repeatedly determined individual operation limitations in order to control the at least one set point parameter.

The flow producing system comprises a control device for controlling a flow producer group having multiple flow producing units. Each flow producing unit is configured to create an individual fluid flow. The fluid flow can be a liquid flow, however is preferably a gas flow, particularly an air flow. For this purpose, in an embodiment the flow producing units being part of one flow producer group are configured as fans or comprise one fan respectively. The flow producing units of a common flow producer group are fluidically connected to a common flow space so that their individual fluid flows can create a total fluid flow for the common flow space.

The control device according to the present disclosure can preferably comprise multiple local control units that are communicatively connected. A local control unit is preferably assigned to one single flow producing unit. For example, a flow producing unit can have a controllable electric motor and the motor control of the electric motor can be the local control unit. Additionally or alternatively to the local control units, the control device can provide a superordinate control or can be a superordinate control that is communicatively connected with the flow producing units. Such a superordinate control can be a central server and/or a Cloud-service, for example.

Preferably, the flow producing units (for example local control units) can be connected to a communication network in wireless and/or wired manner and can thus communicate with one another. Optionally, the superordinate control can be connected to the communication network in wireless and/or wired manner.

For the flow space or its atmosphere a set point parameter is set by means of the control device, such as a set point pressure, a set point temperature, a set point humidity, a set point flow velocity for the total fluid flow, or a set point volume flow rate for the total fluid flow. It is also possible to set multiple set point parameters in any arbitrary combination. By means of the flow producer group also multiple parameters can be controlled in open-loop or closed-loop manner, because degrees of freedom exist for this purpose due to the multiplicity of the flow producing units.

In the context of the method, individual operation limitations are repeatedly determined for each flow producing unit of the flow producer group with increasing operation duration. The operation limitation of a flow producing unit is particularly an operating condition of the flow producing unit within the type-dependent allowed nominal operation limits, the operating condition being, however, not appropriate for the stationary operation of the respective flow producing unit, for example because in this operating condition resonance oscillations are created. An individual operation limitation can also be an operating condition in which the respective flow producing unit does not reach a set minimum efficiency.

The determination of the current individual operation limitations is carried out repeatedly, for example in time-triggered manner in predefined time intervals, and/or in event-triggered manner depending on an event, for example in the event that the at least one set point parameter to be controlled is modified. The time interval and/or the points in time and/or the time controlled for the repeated determination of the respective current individual operation limitation can be defined individually for each flow producing unit, for example depending on the total operation duration of the respective flow producing unit up to present.

For open-loop or closed-loop control of the atmosphere in the flow space according to the at least one predefined set point parameter, a flow producing unit is selected from the flow producer group or multiple or all flow producing units are selected and for each selected flow producing unit an individual set point operating condition is determined. The individual set point operating conditions of the selected flow producing units are determined so that in total, due to the common operation of the flow producing units, the at least one set point parameter is achieved as precise as possible (in open-loop or closed-loop control). During the determination of the individual set point operating conditions, the individual operation limitations are considered for the selected flow producing units respectively in order to avoid a stationary operation in an operating condition that is not appropriate for this purpose.

In doing so, an optimized cooperation of the flow producing units of a flow producer group can be achieved in total.

For example, if an operating condition results from the first determined individual set point operating condition for one flow producing unit that is not appropriate for the stationary operation due to the individual operation limitation, the respective flow producing unit can select another, modified individual set point operating condition that avoids the respective individual operation limitation and particularly is as close as possible to the first determined individual set point operating condition. This adaption is transmitted to the other selected flow producing units so that one or more of the other flow producing units can also adapt their respective set point operating condition in order to achieve the common control objective defined by the at least one set point parameter. This procedure is an embodiment in which each selected flow producing unit avoids stationary operation in an operating condition that shall be avoided due to an individual operation limitation, which can be realized also without a superordinate control, in that the flow producing units coordinate with one another.

Additionally or alternatively, the composition of the selected flow producing units can be varied in order to consider the individual operation limitations of the flow producing units that are used for achieving the open-loop or closed-loop control objective.

In all embodiments the control device can be preferably configured for machine learning. It can have components of machine learning and/or of artificial intelligence (AI). Components here means devices and/or procedures and/or methods that are provided or used in the control device. The machine learning can be any type of machine learning, particularly supervised machine learning, not supervised machine learning, reinforcement machine learning, etc. In the context of machine learning methods for pattern recognition, pattern analysis or pattern prediction can be used.

A component of artificial intelligence (AI component) can be any known realization of an AI component, such as an artificial neural network or a support vector machine (SVM).

Due to the machine learning or the artificial intelligence, actualizations of the individual operation limitations of the flow producing units can be determined particularly well. In addition, adaptions of the set point operating conditions and/or the selection of the flow producing units provided for the operation can be realized very well due to machine learning and/or AI, particularly because very targeted adaptions for avoiding of individual operation limitations can be carried out. Therefore, the object of the open-loop or closed-loop control can be sufficiently quickly achieved.

It is preferred that each flow producing unit is permanently monitored or checked and the individual operation limitation is determined. Optionally, it would also be possible to operate each flow producing unit in a predetermined test mode for determination of its individual operation limitations. For testing or determination of the individual operation limitation, the at least one concerned flow producing unit can be particularly operated in multiple different operating conditions of the flow producing unit. The test or determination of the individual operation limitation can be initiated—as explained—in regular time intervals in time-triggered manner and/or in an event-triggered manner. For example, the electrical and/or mechanical power of the flow producing unit can be varied thereby. In an embodiment, at least one operating parameter of an electric motor of the flow producing unit is varied for this purpose, for example the rotational speed, the torque, the motor current, the motor voltage, the electrical power or an arbitrary combination thereof.

Generally, during the test or determination of the individual operation limitation, an operating and/or flow parameter of the individual fluid flow created by the flow producing unit can be determined as monitored parameter and it can be tested whether this monitored parameter is within an allowable range, for example does not fall below a predefined minimum limit value and/or does not exceed a predefined maximum limit value. In an embodiment, the monitored parameter is an oscillation parameter. Alternatively, the monitored parameter can also be a temperature, a motor current, an electrical power, an efficiency of the flow producing unit, a volume (a sound pressure level and/or a sound intensity level) or the like.

For example, when using a volume level parameter as monitored parameter, an optimization of the operation of the system can be carried out with regard to the emission of noise. For example, in terms of the total volume level, it can be better to operate multiple fans with low power or rotational speed than to operate one or only a few fans with comparable higher power or rotational speed.

The monitored parameter can either be measured directly or determined otherwise. For example, it can be determined based on at least one measurement value by means of calculation, estimation or simulation.

During testing or determination of individual operation limitations, particularly the rotational speed of the electric motor of the flow producing unit can be varied in at least one predefined rotational test speed range within the rotational speed nominal range or via the entire rotational speed nominal range in order to determine one or multiple rotational speeds or rotational speed ranges in resonance oscillations occur. The rotational test speed range can be a rotational speed range in which resonance oscillations or another not desired condition (for example, too high temperature, poor efficiency, etc.) is expected. The rotational speed can be varied within the rotational test speed range continuously or in steps between a minimum rotational speed and a maximum rotational speed. The at least one rotational test speed range can comprise a part of the total allowable rotational speed range (rotational speed nominal range) or can comprise the entire rotational speed nominal range.

A rotational speed at which a resonance oscillation has been recognized can characterize an operation limitation, which defines that the flow producing unit shall not be operated in stationary manner at the rotational speed where the resonance oscillation occurs. Reaching this rotational speed for a short period during a rotational speed change (for example with a rotational speed gradient that is unequal to zero) is allowed. Only the stationary operation for a predetermined minimum duration of, for example, minimum 10 seconds, minimum 30 seconds, or minimum 1 minute is avoided by means of the operation limitation. The operation limitation can thereby exclude a rotational speed range that comprises the rotational speed of the electric motor at which the resonance oscillation has been determined.

For example, for the determination of an oscillation parameter as monitored parameter, an oscillation sensor can be used that measures the oscillation at the electric motor or another component of the flow producing unit and/or a device that is coupled with the flow producing unit in an oscillation transmitting manner. Such a device that is coupled in oscillation transmitting manner can be, for example, a guide device for the created individual fluid flow. An acceleration sensor and/or a microphone can be used as oscillation sensor. The oscillation can be an arbitrary oscillation, for example a harmonic or non-harmonic oscillation. The frequency and amplitude of the oscillation varies particularly depending on the operating condition of the flow producing unit.

It is advantageous, if a standstill duration of a non-selected or of each non-selected flow producing unit is determined. The standstill duration can be compared to a maximum duration. If the standstill duration exceeds the maximum duration, the respective flow producing unit can be put into operation at least for a short period or temporarily in order to check its functionality. For example, a currently selected operated flow producing unit can be at least temporarily turned off and/or reduced in its power and the resting, non-selected flow producing unit can be at least temporarily put into operation so that the predefined control objective is still achieved. In doing so, it can be avoided that due to longer standstill durations, an impairment, for example a strong contamination, freezing, a damage or the like is not recognized and the respective flow producing unit is not available if needed.

If an impairment of a flow producing unit has been identified either by means of the local control unit of the respective flow producing unit or another local control unit or a superordinate control of the control device, the respective affected flow producing unit can be decommissioned for service, repair or maintenance. In the ideal case, the open-loop or closed-loop control objective can still be achieved with the remaining available flow producing units as long as not all of the provided flow producing units operated with maximum power are necessary for this purpose. By means of the flow producer group, therefore, also a redundancy is available in case of failure.

In a preferred embodiment, a total operating duration of each individual flow producing unit of the flow producer group is determined. The total operation duration is the duration during which the respective flow producing unit has been operated starting with the point in time of the first start-up. Additionally or alternatively to the total operation duration, also another total operation parameter can be determined, considering not only the duration, but also the respective power. In a preferred embodiment, when selecting the flow producing units to be operated for achieving the control objective defined by the at least one set point parameter, those flow producing units are considered the total operation parameter characterizes a lower stress, for example, a lower total operation duration and/or a lower accumulated total power that has been provided during the total operation duration. In doing so, the wear and the stress of the flow producing units of the flow producer group can be as uniform as possible, whereby the total lifetime of the flow producer group can be increased.

In a preferred embodiment, each flow producing unit comprises a controllable electric motor and a rotor that is drivingly connected with the electric motor, particularly a fan rotor, which can also be denoted as impeller or fan propeller. Particularly, each flow producing unit has exactly one electric motor and, further preferably, exactly one local control unit. Particularly, each local control unit is a motor control of the electric motor. Superordinate control (central server, Cloud-service) is optional. As explained, the local control units can be in communication connection and can coordinate their operation with each other.

Instead of a fan rotor, the flow producing unit can also comprise a pump rotor that can be driven by means of the electric motor, so that a motor pump unit is formed.

### BRIEF DESCRIPTION OF THE DRAWINGS

Advantageous embodiments of the present disclosure are derived from the dependent claims, the description and the drawing. In the following, preferred embodiments of the present disclosure are described in detail based on the attached drawing. The drawing shows:

FIG. 1 a block diagram of an embodiment of a flow producing system,

FIG. 2 a block diagram of a flow producing unit of the flow producing system of FIG. 1,

FIG. 3 a flow diagram of an embodiment of a method for operating the flow producing system,

FIG. 4 a flow diagram of multiple method steps of an embodiment of the method from FIG. 3,

FIG. 5 an exemplary illustration of a rotational speed n of an electric motor of a flow producing unit during a test or determination of individual operation limitations and

FIG. 6 an exemplary illustration of a monitored parameter in form of an oscillating parameter that is determined and evaluated in the context of the test of a flow producing unit illustrated in FIG. 5.

### DETAILED DESCRIPTION

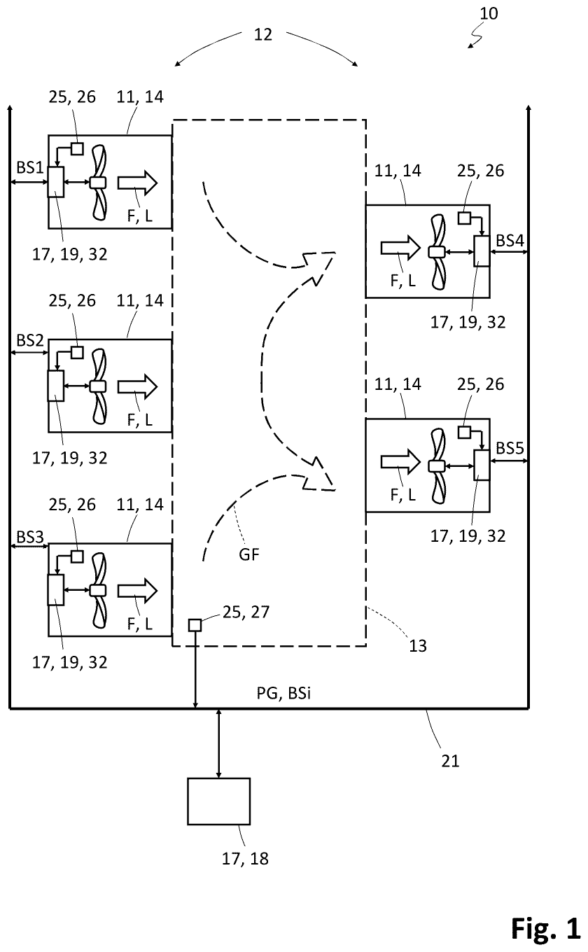

FIG. 1 shows in a schematic block diagram-like illustration a flow producing system 10 having multiple flow producing units 11 that together form a flow producer group 12. These flow producing units 11 of a common flow producer group 12 are fluidically connected to a common flow space 13. Each flow producing unit 11 is configured to create an individual fluid flow F, which is an air flow L in the embodiment. According to the example, each flow producing unit 11 is realized as a fan 14.

The flow producing system 10 has a control device 17 for controlling the flow producer group 12 or the flow producing units 11 being part thereof. The control device 17 can be or comprise a superordinate control 18, which is communicatively connected with the flow producing units 11. Additionally or alternatively, the control device 17 can comprise multiple local control units 19, wherein particularly each flow producing unit 11 comprises one individual local control unit 19. The superordinate control 18 is optional and can be omitted in this case.

The individual fluid flows F of the flow producing units 11 cooperate in the flow space 13 and create a total fluid flow GF there. For example, the flow space 13 can be a room in a building. For example, the flow producing system can be a part of an installed system, such as a ventilation system, an air conditioning system, a heating system or a cooling system. The flow producing units 11 can be connected to the flow space 13 with their pressure or suction side, as schematically illustrated in FIG. 1. The number of flow producing units 11 of one single flow producer group 12 may vary. Each flow producer group 12 has at least two or three flow producing units 11 and, according to the example, fans 14.

The control device 17 is provided with a set point parameter PG for the atmosphere in the flow space 13 that has to be a controlled. The at least one set point parameter PG to be controlled defines, thus, the open-loop or closed-loop control objective for the flow space 13 or for the flow producer group 12. The control objective shall be achieved by means of cooperation of the individual fluid flows F. For this purpose, the operation of the flow producing units 11 of the flow producer group 12, is coordinated by means of control device 17 (multiple local control units 19 and/or superordinate control 18). For this purpose, according to the example, the local control units 19 are connected to a common communication network 21 by means of a local communication interface 20 respectively for forming the control device 17. The communication connection between the local control units 19 or the flow producing units 11 can be wireless and/or wired. Optionally, also multiple flow producer groups 12 of a flow producing system 10 can be connected to the communication network 21, if the flow producing system 10 comprises multiple flow producer groups 12.

In all embodiments the control device 17 (multiple local control units 19 and/or superordinate control 18) can comprise components of machine learning and/or artificial intelligence (AI). Components here means devices and/or procedures and/or methods that are present or used in the control device 17.

The flow producing system 10 can comprise at least one sensor 25. Each sensor 25 is configured to provide a measurement value that either characterizes the total fluid flow GF and/or the atmosphere in the flow space 13 and/or an individual fluid flow F and/or an operating condition of a flow producing unit 11 or a fan 14. The sensor 25, or at least one of the present sensors 25, can be a local sensor and can be communicatively connected to a local control unit 19. The local sensor 26 provides the respectively detected measurement value to the local control unit 19. The local control unit 19 can optionally provide the measurement value for other flow producing units 11 via the communication network 21.

Additionally or alternatively, the sensor 25, or at least one of the present sensors, can be a system sensor 27 that is communicatively connected with multiple local control units 19 and particularly the communication network 21 so that the measurement value of a system sensor 27 is available for multiple or all of the flow producing units or local control units 19. Particularly, the system sensor 27 is configured to detect a measurement value in the atmosphere of the flow space 13 and/or a measurement value of the total fluid flow GF. For example, in doing so, a closed-loop control for the at least one set point parameter PG to be controlled can be realized.

The number of sensors 25 can vary depending on the specific application.

The at least one system sensor 27 can be configured to detect one or more of the following parameters: a temperature in the flow space 13, a pressure in the flow space 13, a flow velocity of the total fluid flow GF in the flow space 13 and/or a volume flow rate of the total fluid flow GF in the flow space 13. Thereby each parameter can be detected at a single measurement site in the flow space 13 or at multiple measurement sites in the flow space 13 arranged with distance to one another by means of one system sensor 27 respectively.

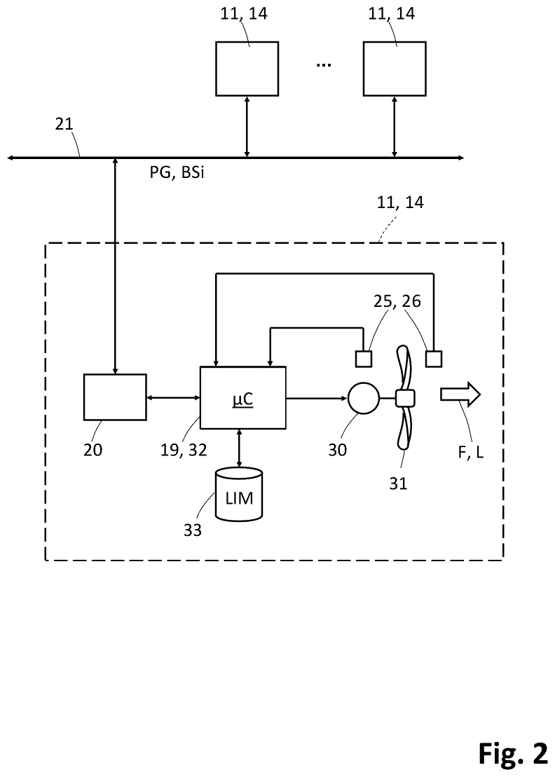

The configuration of a flow producing unit 11 or a fan 14 according to a preferred embodiment is shown in FIG. 2. The fan 14 has a controllable electric motor 30 that is drivingly connected with a fan rotor 31, so that during rotation of the fan rotor 31 the airflow L is created. The electric motor 30 is controlled by means of a local control unit 19. The control unit 19 is preferably the motor control of the electric motor 30 and can form a common unit together with the electric motor 30.

As exemplarily illustrated in FIG. 2, the flow producing unit 11 can comprise one or more local sensors 26. For example, by means of at least one local sensor 26 an operating parameter of the electric motor 30 can be detected. One or more of the following indicated parameters in arbitrary combination can be determined as operating parameter of the electric motor 30: a motor current, a motor voltage, a rotational speed, a temperature and/or an oscillation of the electric motor 30. Additionally or alternatively, a local sensor 26 can detect a parameter of the created fluid flow F and, for example, the airflow L, wherein one or more of the following parameters can be detected in arbitrary combination: a pressure, a flow velocity, a volume flow rate and/or a temperature of the individual fluid flow F.

In the embodiment the flow producing unit 11 comprises a data storage 33 that is communicatively connected with the local control unit 19 or the motor control 32. In the data storage 33, data or parameters can be stored required for the control of the electric motor 30.

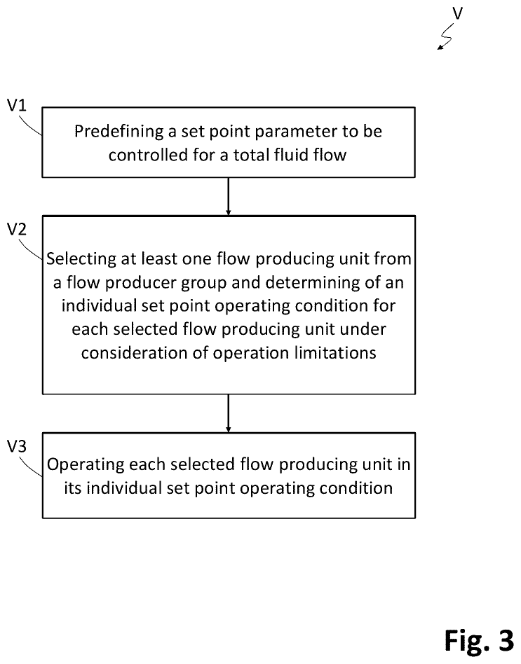

The flow producing system 10 described so far and particularly the flow producing units 11 of a common flow producer group 12 are operated in coordinate manner, as explained in the following based on a method V exemplarily illustrated in FIG. 3.

For the flow space 13 at least one set point parameter PG is predefined. For example, the definition can be carried out via a user interface in or at the flow space 13 and/or another device communicatively connected with the communication network 21, such as a gateway or the superordinate control 18 (first method step V1).

In a second method step V2 multiple or all flow producing units 11 are selected from the flow producer group 12 that shall be operated in order to set the at least one set point parameter PG and thus in order to achieve the predefined open-loop or closed-loop control object. Thereby, an individual set point operating condition BSi (i=1, 2, 3, . . . ) is determined for each selected flow producing unit 11, so that a total fluid flow GF results for the flow space 13 in order to comply with the requirements of the at least one set point parameter PG.

In the context of the selection of the flow producing units 11 and the determination of the individual set point operating conditions BSi, operation limitations LIM of the selected flow producing units 11 are considered, whereby each operation limitation LIM is individually determined for the associated flow producing unit 11 and can be stored in the data storage 33, for example. The determination of the individual operation limitation LIM for each flow producing unit 11 is carried out repeatedly starting with the point in time of the start-up of the flow producing system 10 with increasing operation duration, for example time-triggered in predefined (for example, uniform) time intervals and/or event-triggered. Thus, the individual operation limitation LIM for each flow producing unit 11 is always up-to-date.

The operation limitation LIM of the flow producing unit 11 indicates in which operating conditions the respective flow producing unit 11 shall not be operated in a stationary manner in order to avoid excessive wear, excessive stress or damages. For example, by means of the operation limitation, one or more of the following operating conditions can be excluded for the assigned flow producing unit 11:
an operating condition, particularly a rotational speed n of the electric motor 30, in which a resonance oscillation occurs;
an operating condition in which a temperature of the electric motor 30 or the local control unit 19 exceeds a temperature limit value;
an operating condition in which the flow producing unit 11 or the fan 14 drops below a minimum efficiency;
an operating condition in which an operating noise of the flow producing unit 11 exceeds a predefined limit value;
an operating condition in which a defined power limit value (for example allowable maximum power in permanent operation) is exceeded.

In the second method step V2 the selected flow producing units 11 are coordinated to one another so that their set point operating conditions are respectively outside the operation limitation and the control objective can be achieved that is defined by the at least one set point parameter.

Subsequently, in a third method step V3 the selected flow producing units 11 are operated according to the determined set point operating condition BSi.

If for the current operation not all of the flow producing units 11 of a flow producer group 12 are selected and operated, one or more flow producing units 11 can stand still. The standstill duration of each flow producing unit 11 is detected and compared to a maximum duration. If the standstill duration during which the respective flow producing unit 11 stands still without interruption exceeds the maximum duration, it can be at least temporarily put into operation, for example in order to test its functionality. In doing so, it can be avoided that a flow producing unit 11, that stands still for a longer period, is impaired in its function without being recognized. For example, in this context a selected, currently operated flow producing unit 11 can be reduced in its power or can be turned off and as a replacement, a flow producing unit 11 can be operated that has been at a standstill so far, in order to replace the reduced or turned off flow power. In doing so, it can be determined whether all of the flow producing units 11 of a flow producer group 12 are operational.

Due to the resulting degrees of freedom or redundancies of the multiple flow producing units 11 of the common flow producer group 12, also other boundary conditions can be considered for optimization of the flow producing system 10. For example, as a boundary condition, the stress or wear of the flow producing units 11 can be equalized as far as possible. For this purpose, a total operation parameter can be determined for each flow producing unit 11. The total operation parameter of an assigned flow producing unit 11 describes the stress that has occurred up-to-date, beginning with its start-up. In the simplest case, the total operation parameter can be the total operation duration of the flow producing unit 11. In addition to the total operation duration, also the electrical and/or mechanical power, which has been set during operating phases of the flow producing unit 11, can be considered as an option. For example, a cumulative power value (for example, energy) during the total operation duration can be determined as total operation parameter. Optionally, thereby, different power ranges of the flow producing unit 11 can be weighted differently, so that, for example, stresses of the flow producing unit 11 in a maximum power range are considered with a higher weight in the total operation parameter than operating phases with medium or low power within the nominal power range of the respective flow producing unit 11.

Based on the total operation parameter during the selection and/or during determination of the individual set point operating conditions BSi, those flow producing units 11 can be prioritized for which the respective total operation parameter indicates a lower stress. In doing so, the flow producing units 11 can be selected in prioritized manner according to the order of the respectively assigned total operation parameters, starting with the total operation parameter that characterizes the least stress, for example the smallest total operation parameter. Starting from this flow producing unit 11, the potentially additionally required flow producing units 11 of the flow producer group 12 can be selected in the order of their total operation parameters.

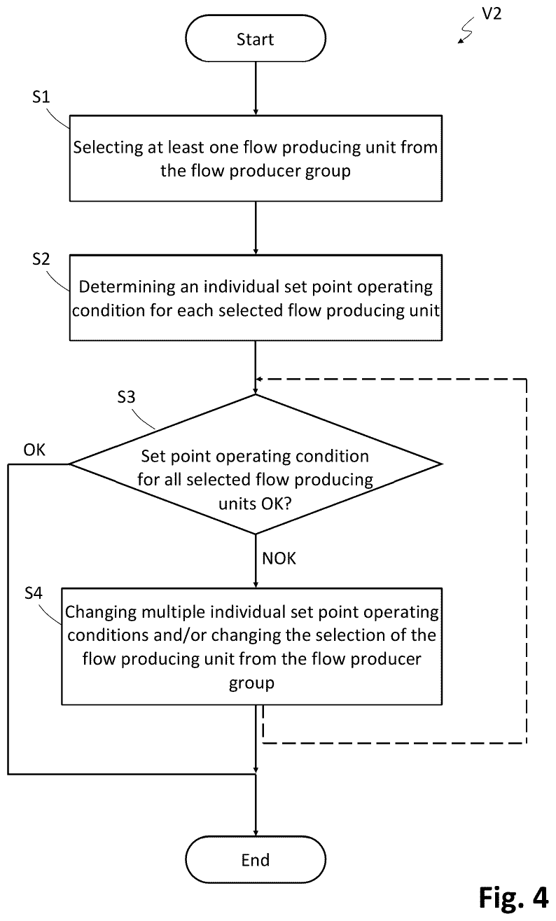

In the flow diagram according to FIG. 4, the second method step V2 is shown in more detail in an embodiment of the method V. In a first sub-step S1, first the selection of the at least one flow producing units 11 can be carried out and subsequently the respective individual set point operating condition BSi can be determined for each selected flow producing unit 11 (second sub-step S2).

In the following, in a third sub-step S3, it is checked whether each individual set point operating parameter BSi corresponds to an allowable stationary operating condition of the respective flow producing unit 11 or whether it is excluded by an operation limitation LIM as stationary operating condition.

If it results from the third sub-step S3 that all individual set point operating conditions BSi are allowed as stationary operating conditions (branch OK from third sub-step S3), the second method step V2 is terminated and the method V can be continued in the third method step V3, as illustrated in FIG. 3. Otherwise (branch NOK from third sub-step S3) in a fourth sub-step S4, either the selection of the flow producing unit 11 from the flow producer group 12 is changed and/or the individual set point operating condition BSi or the individual set point operating conditions BSi of the selected flow producing units 11 are adapted so that all of the individual set point operating conditions BSi are not excluded by an operation limitation LIM for use as stationary operating condition.

The selection of the flow producing units 11 and/or the change of the individual set point operating conditions BSi can be carried out iteratively in a loop of the third sub-step S3 and the fourth sub-step S4, as illustrated by means of the dashed arrow in FIG. 4.

It can be advantageous to execute the adaption in the fourth sub-step S4 once, so that a method can be continued in the third method step V3 according to FIG. 3 subsequently.

In an embodiment a local control unit 19 can adapt the individual set point operating condition BSi that has been determined for the latter, in order to avoid a stationary operation excluded by the individual operation limitation LIM. For example, for this purpose, the power (particularly rotational speed n) can be increased or lowered, so that the respective flow producing unit 11 provides a higher or lower power. This power difference is transmitted from the local control unit 19 to the other selected flow producing units 11, that as a result therefrom compensate the power difference, so that for all other selected flow producing units 11 an individual set point operating condition BSI results that is not excluded by the respective individual operation limitation LIM. For example, one or more of the other selected flow producing units 11 can increase or lower their respective power, so that in total the predefined open loop or closed-loop control objective is achieved.

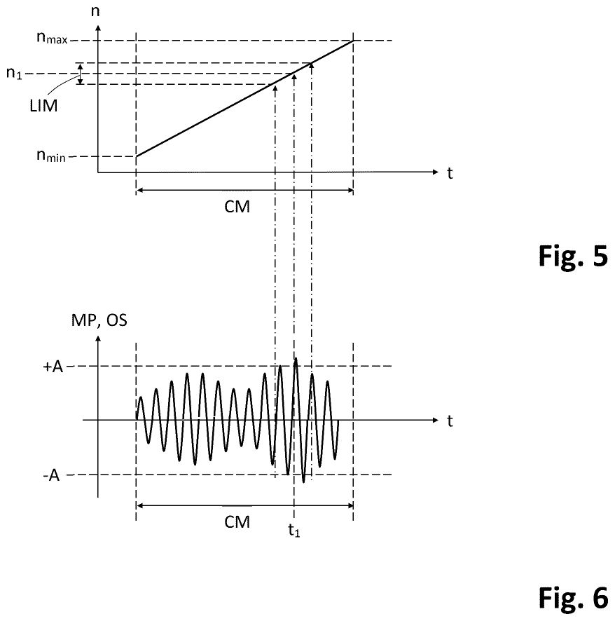

In order to avoid a stationary operation in an inappropriate operating condition, it is provided that the operation limitation LIM for each flow producing unit 11 is repeatedly determined. For this purpose, the flow producing unit 11 can be operated during a test CM, or determination of the individual operation limitation, in at least one defined operating condition, as schematically illustrated in FIG. 5 by way of example of the rotational speed n of the electric motor 30. During the test or determination of the individual operation limitation of the flow producing unit 11, a monitored parameter MP is monitored based on which an undesired stationary operating condition can be defined.

According to the example, an oscillation parameter OS is used as monitored parameter MP. The oscillation parameter OS can describe an oscillation of the flow producing unit 11 or the fan 14 and can be measured, for example, by means of an acceleration sensor or microphone or another suitable oscillation sensor. Particularly, such an oscillation sensor can be a local sensor 26 of the flow producing unit 11 or the fan 14. It can be arranged on a component of the fan 14 or on a device that is coupled with the fan 14 in terms of the flow. By means of the oscillation parameter OS as monitored parameter MP, resonance oscillations at specific rotational speeds n of the electric motor 30 or the fan rotor 31 can be determined, for example, and respective rotational speed ranges can be excluded by defining an operation limitation LIM, as explained based on FIGS. 5 and 6 in the following by way of example.

For example, the rotational speed n of the electric motor 30 or the fan rotor 31 can be varied during the test CM or determination of the individual operation limitation within a predefined rotational speed test range from a minimum rotational speed nₘᵢₙ up to a maximum rotational speed nₘₐₓ. In the embodiment illustrated in FIG. 5 the rotational speed n is continuously and, for example, linearly increased. The rotational speed n could also be changed in the rotational speed test range in a stepwise manner or without steps along a non-linear curve. The rotational speed test range from the minimum rotational speed nₘᵢₙ up to the maximum rotational speed nₘₐₓ can either at least contain rotational speeds in which a resonance oscillation is expected or can also comprise the entire rotational speed nominal range of the flow producing unit 11 or the fan 14.

During variation of the rotational speed n in the context of the test CM, the monitored parameter MP and according to the example the oscillation parameter OS is monitored and it is checked whether the monitored parameter MP is within a predefined allowable range. For example, a maximum allowable absolute value for the oscillating amplitude can be defined for the oscillation parameter OS.

By way of example and for explanation purposes, exceeding of the allowable amplitude A by the oscillation parameter OS is illustrated in FIG. 6 at a first point in time t1. At this first point in time t1, the rotational speed n of the electric motor 30 has a first rotational speed n₁. A stationary operation with a rotational speed n corresponding to the first rotational speed n₁ is thus not suitable and is avoided by a respective operation limitation LIM. For this purpose, a rotational speed range can be defined as operation limitation LIM, for example, that is not suitable for the stationary operation and that comprises the first rotational speed n₁. Thus, oscillations with amplitudes can be avoided that exceed the amplitude limit value A, as schematically illustrated based on FIGS. 5 and 6.

If a first determined individual operating condition BSi is within the rotational speed range around the first rotational speed n₁ excluded by the operation limitation LIM, the control device 17, particularly the respective local control unit 19, can adapt the first determined individual operating condition BSi and can set the rotational speed to the lower limit value or the upper limit value of the rotational speed range excluded by the operation limitation LIM in order to deviate as little as possible from the first determined individual operating condition BSi. As explained, the power difference created thereby can be compensated by one or more of the other selected flow producing units 11.

Alternatively or additionally to the oscillation parameter OS, another monitored parameter MP can be monitored, such as an operating temperature of the electric motor 30 and/or the local control unit 19. By means of the operation limitation LIM, also other operating conditions and particularly rotational speed ranges can be excluded in which the flow producing unit 11 does not reach a minimum efficiency.

The present disclosure refers to a method for operating a flow producing system 10 as well as a flow producing system 10 configured to carry out the method. The flow producing system 10 has at least one flow producing unit 12, having multiple flow producing units 11 respectively. The flow producing units 11 can be fans, for example. The flow producing units 11 of a common flow producer group 12 are fluidically connected with the same flow space 13. The flow producing units 11 of a common flow producer group 12 are controlled in a coordinate manner by means of a control device 17, so that a predefined open-loop or closed-loop control objective is achieved that is defined by at least one set point parameter PG. For this purpose, one or more flow producing units 11 are selected from the flow producer group 12 and for the selected flow producing units 11 an individual set point operating condition BSi is determined respectively. The respectively determined set point operating condition BSi is checked based on a respective individual operation limitation LIM whether it is allowed for a stationary operation. If this is not the case for one or more of the determined set point operating conditions BSi, two or more set point operating conditions BSi are changed until all set point operating conditions BSi of the selected flow producing units 11 are allowed, that means are not excluded for the stationary operation by the respective operation limitation LIM. Thereby it is additionally or alternatively possible to change the selection of flow producing units 11 from the common flow producer group 12.

### LIST OF REFERENCE SIGNS

10 flow producing system
11 flow producing unit
12 flow producer group
13 flow space
14 fan
17 control device
18 superordinate control
19 local control unit
20 communication interface
21 communication network
25 sensor
26 local sensor
27 system sensor
30 electric motor
31 fan rotor
32 motor control
33 data storage
A amplitude limit value
BSi set point operating condition of flow producing unit (i=1, 2, 3, . . . , n)
CM test
F individual fluid flow
GF total fluid flow
L air flow
LIM operation limitation
MP monitored parameter
n rotational speed
n₁ first rotational speed value
nₘₐₓ maximum rotational speed
nₘᵢₙ minimum rotational speed
OS oscillation parameter
PG set point parameter
S1 first sub-step
S2 second sub-step
S3 third sub-step
S4 fourth sub-step
t time
t1 first point in time
V method
V1 first method step
V2 second method step
V3 third method step

1. A method for operating a flow producing system comprising a control device and a flow producer group that can be controlled by means of the control device and that comprises multiple flow producing units, which are respectively configured to create an individual fluid flow, wherein the flow producing units are fluidically connected with a common flow space, wherein the method comprises:
setting at least one set point parameter that is to be controlled for atmosphere in the flow space,
selecting at least one flow producing unit from the flow producer group and determining an individual set point operating condition for each selected flow producing unit under consideration of repeatedly determined individual operation limitations in order to control the at least one set point parameter, and
wherein each flow producing unit is operated in multiple different operating conditions for determination of its individual operation limitation.

2. The method according to claim 1, wherein the individual operation limitations of the flow producing units are repeatedly determined in a time-triggered and/or event-triggered manner.

3. (canceled)

4. The method according to claim 1, wherein for the determination of the individual operation limitation of a flow producing unit, operating conditions having different mechanical and/or electrical power of the flow producing unit are set.

5. The method according to claim 1, wherein for determination of the individual operation limitation of a flow producing unit, a monitored parameter that depends on operation of the flow producing unit is determined and it is checked whether the monitored parameter is within a predefined allowable range.

6. The method according to claim 5, wherein the monitored parameter is an oscillation parameter.

7. The method according to claim 1, wherein a standstill duration of a non-selected flow producing unit is determined and the flow producing unit is at least temporarily operated, if the standstill duration exceeds a maximum duration.

8. The method according to claim 1, wherein a total operation parameter of each flow producing unit is determined and wherein when selecting the flow producing units from the flow producer group the flow producing units are prioritized that have a total operation parameter characterizing lower stress of the flow producing unit.

9. The method according to claim 1, wherein each individual operation limitation defines at least one operating condition of the respective flow producing unit, which is inappropriate for a stationary operation of the flow producing unit.

10. The method according to claim 1, wherein the at least one set point parameter is or are one or more of the following indicated parameters in arbitrary combination: a pressure of the atmosphere in the flow space, a temperature of the atmosphere in the flow space, a humidity of the atmosphere in the flow space, a flow velocity of a total fluid flow in the flow space and/or a volume flow rate of the total fluid flow in the flow space.

11. A flow producing system comprising a control device and a flow producer group that can be controlled by means of the control device and that comprises multiple flow producing units that are respectively configured to create an individual fluid flow, whereby the flow producing units are fluidically connected to a common flow space, wherein the control device is configured to carry out the following method:
setting at least one set point parameter to be controlled for the flow space,
selecting at least one flow producing unit from the flow producer group and determining an individual set point operating condition for each selected flow producing unit under consideration of repeatedly determined individual operation limitations in order to control the at least one set point parameter, and
wherein each flow producing unit is operated in multiple different operating conditions for determination of its individual operation limitation.

12. The flow producing system according to claim 11, wherein each flow producing unit additionally comprises a controllable electric motor and a rotor that is drivingly connected with the electric motor.

13. The flow producing system according to claim 11, wherein the control device comprises multiple local control units communicatively connected with one another and wherein each flow producing unit comprises one individual local control unit.

14. The flow producing system according to claim 12, wherein the control device comprises multiple local control units communicatively connected with one another and wherein each flow producing unit comprises one individual local control unit, and wherein each local control unit is a motor control of the electric motor.

15. The flow producing system according to claim 1, wherein the control device comprises a superordinate control that is communicatively connected with the flow producing units.

16. (canceled)

17. The method according to claim 2, wherein for the determination of the individual operation limitation of a flow producing unit, operating conditions having different mechanical and/or electrical power of the flow producing unit are set.

18. The method according to claim 17, wherein for determination of the individual operation limitation of a flow producing unit, a monitored parameter that depends on operation of the flow producing unit is determined and it is checked whether the monitored parameter is within a predefined allowable range.

19. The method according to claim 18, wherein the monitored parameter is an oscillation parameter.

20. The method according to claim 19, wherein a standstill duration of a non-selected flow producing unit is determined and the flow producing unit is at least temporarily operated, if the standstill duration exceeds a maximum duration.
